(19) United States
(12) Patent Application Publication
(10) Pub. No.: US 2026/0253450 A1
(43) Pub. Date: Aug. 27, 2026

(54) END USER BEHAVIOR DETECTION TOOL AND INTREPRETIVE NEURAL NETWORK SYSTEM FOR AIRCRAFT

(71) Applicant: Gulfstream Aerospace Corporation, Savannah, GA (US)

(72) Inventors: Kristin Medin, Savannah, GA (US); Katherine Young, Savannah, GA (US); Evan Lowhorn, Savannah, GA (US)

(73) Assignee: Gulfstream Aerospace Corporation, Savannah, GA (US)

(21) Appl. No.: 19/061,594

(22) Filed: Feb. 24, 2025

(51) Int. Cl. G06V 40/20; G06V 10/82; G06V 20/52; G06V 20/59; G06V 40/16

(52) U.S. Cl. CPC G06V 40/28; G06V 10/82; G06V 20/52; G06V 20/59; G06V 40/174

(57) ABSTRACT

A method that inconspicuously assesses a behavior of an occupant. The method can include installing a sensor in an area to detect a behavior of the occupant in the area. The method can also include transmitting information obtained by the sensor to a computing device coupled with the sensor. Further, the method can include extracting a data point from the information. A machine-learning algorithm is applied to extract the data point that includes body positions, facial patterns, extremity positions, and finger movements of the occupant. The finger movements in relation to touchpoints in the area are included within the data point. The method can also include determining, based on the data point, an instance in which the occupant required assistance within the area.

### TECHNICAL FIELD

The present invention relates generally to observing conduct of occupants within a space, and more particularly to identifying needs of passengers on an aircraft by using artificial intelligence (AI)/machine-learning (ML) to analyze video, audio, and motion sequences to determine the needs of the passengers in a cabin area of an aircraft during a testing period.

### BACKGROUND

Currently, human-centered designers have always leveraged classic tools in quantifying work in the utility of a cabin space in an airplane. Nevertheless, it can be harder to measure, quantify and objectively prove engagement and distraction. For example, in the context of aviation, it can be harder to prove perception of comfort or lack thereof of a passenger in an aircraft cabin. Simple technology such as go-pro cameras that can capture video require significant man hours for user behavior experts to analyze. In addition, the go-pro cameras are often not conspicuously hidden. The passengers are often aware of their presence. As a result, the conscious behavior of the participants in the studies can be impacted by their awareness that they are being watched.

A need exists to identify when occupants within a space (e.g., an aircraft passenger compartment) are behaving naturally and when they require assistance. The occupants may not be as forthcoming as to when they require assistance if they are aware that they are being watched. Nevertheless, service providers need to be aware of the needs of the occupants to more efficiently serve the occupants and also to more efficiently perform their duties outside of providing assistance to the occupants.

As such, a system is needed to be able to identify when the occupants within a space require assistance when the occupants are behaving naturally.

Accordingly, it is desirable to provide a system of inconspicuously observing occupants within a space. Furthermore, other desirable features and characteristics will become apparent from the subsequent detailed description and the appended claims, taken in conjunction with the accompanying drawings and this background.

### BRIEF SUMMARY

Various embodiments of a method and system to inconspicuously assess behavior of an occupant are described.

In a first non-limiting embodiment, a method for inconspicuously assessing behavior of an occupant includes, but is not limited to, installing a sensor in an area to detect a presence, proximity, and behavior of an occupant. The method can also include, but is not limited to, transmitting information obtained by a sensor to a computing device coupled to the sensor. The method can further include, but is not limited to, extracting a data point from the information. A machine-learning algorithm can be applied to extract the data point that can include, but is not limited to, body positions, facial patterns, extremity positions, and finger movements of the occupant. The finger movements of the occupant in relation to touchpoints in the area are included within the data point. The method can also include, but is not limited to, determining, based on the data point, an instance in which the occupant required assistance within the area.

In another non-limiting embodiment, a non-transitory machine-readable storage medium that provides instruction that, when executed by a processor, are configurable to cause the processor to perform operations that include installing a sensor in an area to detect a presence, proximity, and behavior of an occupant. The processor's operations can also include, but are not limited to, transmitting information obtained by the sensor to a computing device coupled to the sensor. The processor's operations can further include, but are not limited to, extracting a data point that includes body positions, facial patterns, extremity positions, and finger movements of the passengers. The finger movements in relation to touchpoints in the area can be included within the data point. The processor's operations can also include, but are not limited to, determining, based on the data point, an instance in which the occupant required assistance within the area.

In yet another non-limiting embodiment, a computing system can include, but is not limited to, a non-transitory machine-readable storage medium that stores software. The computing system can further include, but is not limited to, a processor coupled to the non-transitory machine-readable storage medium, to execute the software to perform operations. The operations can include, but are not limited to, installing a sensor in an area to detect a presence, proximity, and behavior of an occupant in the area. The operations can also include, but are not limited to, transmitting information obtained by the sensor to a computing device coupled with the sensor. Further, the operations can include, but are not limited to, extracting a data point from the information. A machine-learning algorithm can be applied to extract the data point that includes, but is not limited to, body positions, facial patterns, extremity positions, and finger movements of the passengers. The finger movements in relation to touchpoints in the area are included within the data point. The operations can also include, but are not limited to, determining, based on the data point, an instance in which the occupant required assistance within the area.

### BRIEF DESCRIPTION OF THE DRAWINGS

The present invention will hereinafter be described in conjunction with the following drawing figures, wherein like numerals denote like elements, and

FIG. 1 is a perspective view illustrating a non-limiting embodiment of a plurality of sensors positioned on and around a reclining seat made in accordance with the teachings of the present disclosure;

FIG. 2A is a perspective view illustrating the sensors positioned on and around the reclining seat of FIG. 1 with a passenger seated in an upright position;

FIG. 2B is a perspective view illustrating the sensors positioned on and around the passenger seat of FIG. 1, with a passenger leaning forward;

FIG. 2C is a perspective view illustrating the sensors positioned on and around the passenger seat of FIG. 1, with the passenger in a reclining position;

FIG. 3 Illustrates a flow diagram of a non-limiting embodiment of a training method in accordance with the teachings of the present disclosure;

FIG. 4 illustrates a flow diagram of a non-limiting embodiment of a deployment method in accordance with the teachings of the present disclosure;

FIG. 5 is a block diagram of a non-limiting embodiment of a computer-based device; and

FIG. 6 is flow chart that illustrates a non-limiting embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

The following exemplary embodiments illustrate systems and methods in which, in the context of an aircraft cabin, the behavior of occupants in the cabin area can be observed and recorded during a testing period. Service providers may want to be alerted on the best time intervals to assist the occupants. Moreover, the cabin and crew members may want to know the various body positions of the occupants when they require assistance, and also when they require solitude and privacy. As such, the cabin and crew members may also want to know the time intervals when the occupants may require privacy. The body positions can include the facial expressions, head movements, and finger movements of the occupants before they request assistance.

A process or system is disclosed herein in which, for example, the occupants in a cabin area of an aircraft are observed inconspicuously during a testing period. Inconspicuous sensors can be placed around each seat in a cabin during a testing period. The sensors can be configured with a universal serial bus (USB) camera with electrical/optical (EO), infrared (IR), and thermal capabilities. The sensors can thereby sense video, audio, motion, and changes in cabin settings during the testing period. The sensors can be present on and around each seat without each occupant being aware of their presence. During a testing period, the body movements of the passengers can be detected. The body movements can include the head and eye movements of the passengers. The body movements can also include the finger movements of the passengers. The sensors can also capture the movement of each occupant's extremities. The extremities, can include, but are not limited to, movements in relation to the hand, knee, and ankle. The sensors can thereby sense the coordinates and movements in relation to the hands, knees, and ankles of the occupants as well. The sensors can be designed to sense the video, motion, and audio of the passengers during the testing period. The sensors can sense the body movements and audio of the passengers when the passengers require assistance during the testing periods. The sensors can be coupled to a computing system which incorporates an artificial intelligence (AI) model.

The AI model on the computing system can be trained to collect the sensed data in relation to the video, motion, and sound of the occupants that the sensors transmit to the computing system. Further, the AI model can also be trained to perform feature extraction, categorization, and image augmentation of the video, motion, and sound which the sensors sense of the occupants. The feature extraction and image augmentation can include the features and image of the occupants'head, body, and finger movements when requesting assistance. The AI model can also be trained to extract body key point coordinates. The body key point coordinates can include the body movements and hand movements of the occupants when they requested assistance, and also when they performed activities without assistance. The AI model can also be trained with respect to data augmentation and feature extraction with respect to the collected video and audio transmitted by the sensors. The video and audio of when the occupants requested assistance and performed activities without assistance can be part of the data augmentation and feature extraction. After the AI model is trained, the AI model can be deployed in multiple intervals.

Through the model deployment, the AI model through the computing system can collect the video, motion, and audio feed from the sensors in multiple intervals. The sensors can continuously send the video, motion, and audio feed to the computing system in multiple intervals during the testing period. The sensors can also send information on cabin settings such as the cabin temperatures as well. The deployment process can also involve frame extraction and extraction of body key point coordinates. The body positions and movements including the head, extremity, and finger positions of the occupants can be extracted. The system can identify the body positions and coordinates in which the occupants requested assistance during the testing period. The deployment process can further include feature extraction and model inference for feature input.

As such, the features of the occupants, including their head, body, extremity, and finger movements of when they requested assistance can be extracted. The AI model can be alerted to the body positions of when the occupants request assistance, and then infer in future time intervals when the occupants may request assistance. The deployment can also include a process result in a cabin application. Crew members in the cabin can be alerted as to when the occupants will request assistance based on the body positions, and various dialogue of the occupants. The crew members can also more efficiently perform their duties with the knowledge of when the occupants require assistance and when the occupants will not require assistance.

The sensed video, audio, motion, and cabin settings of by the sensors, the training of the AI model, and the deployment of the AI model can provide several technical advantages. The computing system can more efficiently determine when the occupants will request assistance and alert crew members when the occupants will request assistance. The computing system can identify the body positions in which the occupants will request assistance, thereby also provide timely alerts to crew members as to when the occupants may request assistance. The cabin schedule can also be performed more efficiently. The crew members can be aware when they are needed for assistance, and when they should perform their duties in the cabin. Unnecessary computing resources are not expended trying to determine when the occupants may require assistance accordingly.

A greater understanding of the actions being performed by the sensors, the training process, and the deployment process may be obtained through a review of the illustrations accompanying this application together with a review of the detailed description that follows.

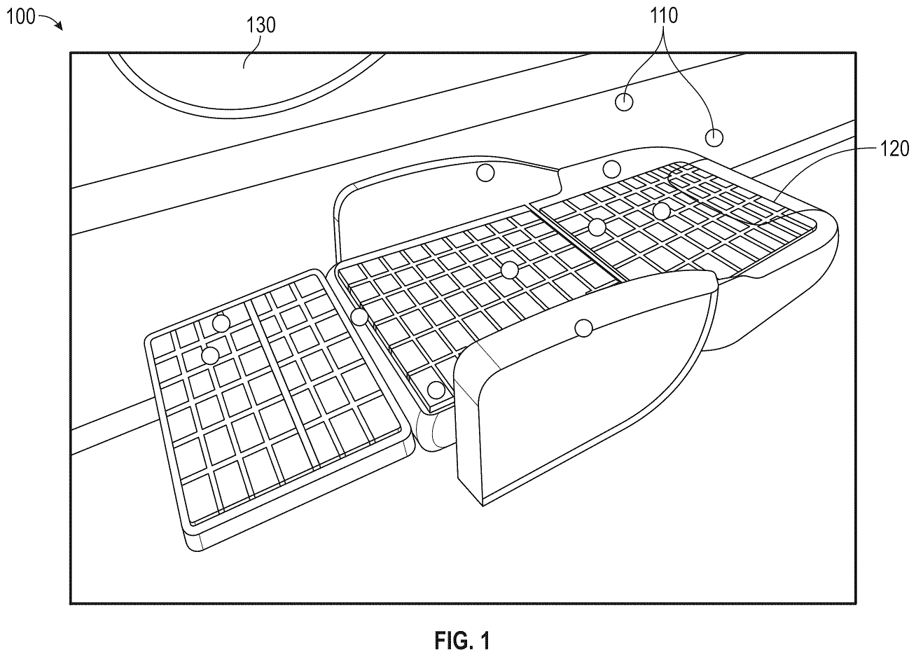

In FIG. 1, a non-limiting embodiment of a system 100 is illustrated in a cabin area of an aircraft or plane. The system 100 can be configured to identify behaviors of occupants to identify time intervals when the occupants may require assistance within the cabin area. Although this discussion herein centers around the interior of an aircraft cabin, this is only to provide the reader with context. It should be understood that the teachings of the present disclosure are compatible with the interior of other vehicles as well. In addition, the teachings of the present disclosure are not limited to use with vehicles but rather are compatible with any compartment in any context that is configured to be occupied by, or otherwise accommodate human occupants. During a testing period, a plurality of sensors 110 can be inconspicuously placed around a cabin seat 120. The sensors 110 can each be equipped with a USB camera, and be able to sense video, motion, audio, and cabin settings during the testing period. Any occupant in the cabin seat 120 may be unaware of the presence of the plurality of sensors 110. A window 130 can be adjacent to the sensors 110 and the cabin seat 120. Throughout the cabin area of the plane, various other cabin seats 120 and sensors 110 can be similarly positioned as the sensors 110 and the cabin seat 120 that are illustrated. The sensors 110 can be placed in a way so that any occupant/passenger is unaware that any of the sensors 110 are present. The sensors 110 can be configured to sense the video, motion, and audio of the passenger for a testing period. The system 100 can be set for a testing period of a few minutes, hours, or days. The testing period can be of any length, and can be repeated in multiple time intervals.

Referring again to FIG. 1, the system 100 can be set to a testing period. In the testing period, the sensors 110 can sense the various behaviors of the passenger or occupant. The sensors 110 can be coupled to a computing system that applies artificial intelligence (AI) and machine-learning (ML) algorithms when receiving the sensed video, motion, and audio of the passenger's behavior during the testing period. In multiple and continuous time intervals, the sensors 110 can sense the video, motion, and audio in relation to the behavior of the occupant to enable the computing system to identify the various needs of the occupant. In other words, the sensors 110 can be attempting to relay to the computing system when the occupant needs assistance. The occupant can need assistance to adjust cabin settings such as temperature and lights in the cabin. The occupant may need assistance for a medical emergency. The occupant may also need assistance when the occupant is thirsty or hungry. The sensors 110 can continuously sense the motion and audio of the behavior of the occupant and send the motion and audio of the occupant to the computing system.

In FIG. 1, the computing system, in response to receiving the video, motion, and audio from the sensors 110, can apply the AI and ML algorithms to the received video, motion, and audio of the occupant. Moreover, the algorithms can identify in what intervals that the occupant/passenger would need assistance. The computing system, through the algorithms, can determine when the occupant would want the lights dimmed, or the cabin temperature to be raised. Further, the computing system can also identify when the user may not need assistance and want to go to sleep. The computing system can also identify if the occupant has a specific medical condition that would require attention at certain time intervals. The crew members within the cabin area can then be alerted to the results that the computing system has obtained, and thereby be aware of the particular needs of each occupant in the cabin area. The crew members can more efficiently assist each occupant in the cabin area as they are more aware of the needs for each occupant. The crew members can become aware of the various body positions, including head positions, extremity positions, and finger movements of the occupants when they require assistance, or when they require privacy.

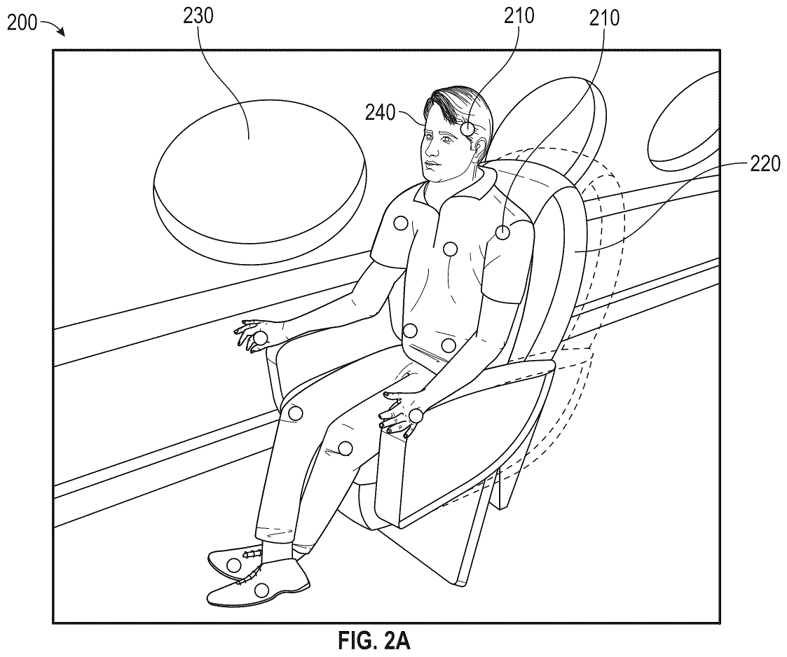

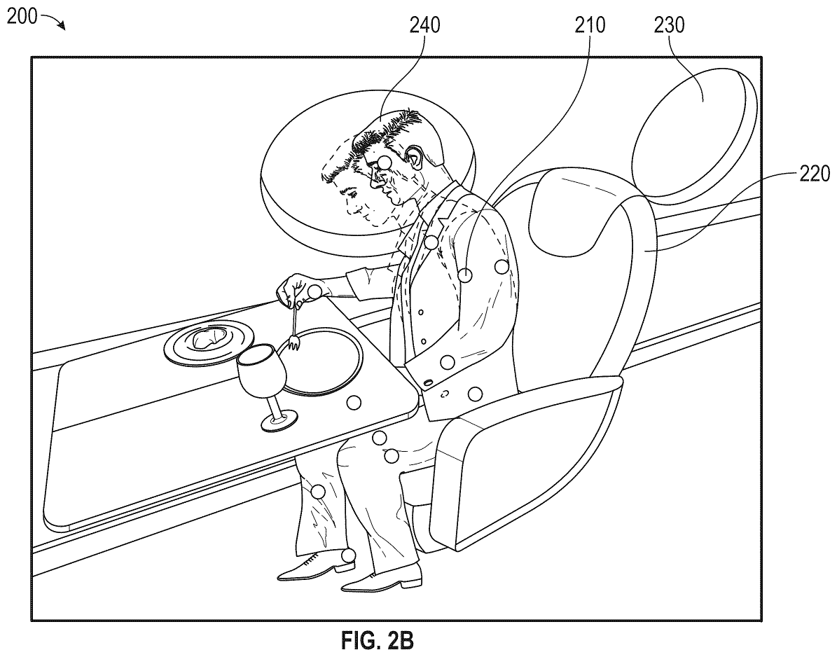

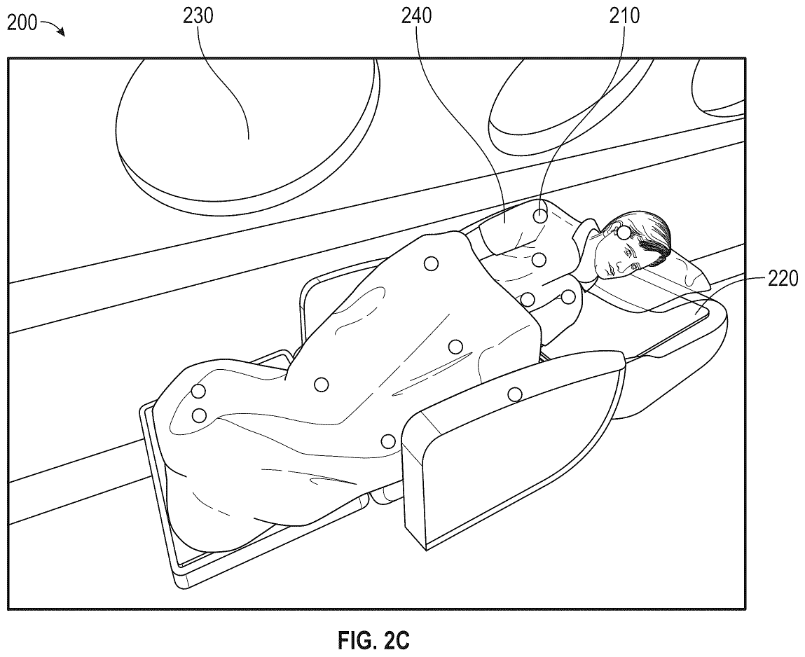

In FIG. 2A, a non-limiting embodiment of a system 200 is illustrated in which sensors 210 are positioned around the passenger seat 220 while the occupant 240 is seated in an upright position next to the window 230. The system 200 can be configured to identify various behaviors of the occupant 240 during a testing period to identify instances when the occupant 240 may require assistance. The sensors 210 can be inconspicuously placed on and around the occupant 240 while the occupant 240 is seated during a testing period. As in FIG. 1, the sensors 210 can be configured with a USB camera and can sense a video, motion, and audio of occupants in the cabin area. The sensors 210 can also sense the cabin settings such as the temperature and light in the cabin area as well. The occupant 240 can be unaware of the presence of the sensors 210 and that the sensors 210 are sensing video, audio, and motion of the occupant 240 during the testing period. The sensors 210 can also transmit the sensed video, audio, and motion to a computing system that is communicatively coupled to the sensors 210.

In FIG. 2A, the computing system can receive the sensed video, audio, and motion that the sensors 210 have sensed throughout the testing period in multiple time intervals. As the occupant 240 is in a seated and upright position, the computing system can identify, using the AI incorporated within the computing system, when the occupant 240 required food and liquids and various assistance. Further, the computing system can identify, using the AI, when the occupant 240 would want cabin settings adjusted, such as the temperature being increased, or the cabin lights brightened so that the occupant can eat his/her food or read materials within the cabin area. In multiple time intervals throughout the testing period, the computing system can be made aware, from the sensed video, audio, and motion, when the occupant 240 would press a “call” button for assistance for specific needs when the occupant is seated in the upright position. The crew members servicing the cabin area can the provide the occupant 240 with materials needed for a meal or other activities based on the requested assistance by the occupant 240. When the occupant 240 is seated upright, the computing system can become aware of the time intervals when the occupant 240 may require assistance, and also the time intervals when the occupant 240 may not require assistance. In addition, the sensors 210 can also sense relevant interactions between the occupant and other occupants during the testing period within the cabin area.

In FIG. 2B, the system 200 is illustrated in which the occupant 240 is leaning forward within the passenger seat 220 next to the window 230. In different body positions, the occupant 240 can be performing different activities. The occupant 240 may inevitably be eating a meal as opposed to reading and relaxing when the occupant 240 is leaning forward. The assistance required may then change with the different body positions of the occupant 240. The sensors 210 can sense the video, audio, and motion of the occupant 240 throughout the testing period when the occupant 240 is leaning forward during the testing period. As the occupant 240 is leaning forward, the occupant 240 can be eating food, drinking coffee, and performing other tasks that the occupant 240 would typically perform when leaning forward within the passenger seat 220. The occupant 240 can therefore press a call button for assistance multiple times throughout the testing period when the occupant 240 is leaning forward. The sensors 210 can relay the sensed video, audio, and motion of the occupant 240 to the computing system continuously throughout the testing period. The computing system can then be aware, using the AI, when the passenger would require additional materials for a meal, such as additional silverware, coffee and dessert to complete a meal. The crew members servicing the cabin area can be alerted and provide the occupant 240 with the additional materials as well.

In FIG. 2B, the computing system can also be alerted, from the sensed video, audio, and motion from the sensors 210, when the occupant 240 has completed a meal and would like any dishes and silverware associated with the meal to be taken away. As such, the computing system can be made aware that the occupant 240 would like additional space so that the occupant 240 can move the passenger seat 220 back into an upright position. In other embodiments, the occupant 240 may be seated at a club seat grouping area, and may just want the table surface cleared so that the occupant 240 can place a laptop or tablet on the table to use. The occupant 240 may also just want to stow the table for use at a later interval as well. The computing system can thereby be aware from the video, audio, and motion sent by the sensors 210 when the occupant 240 would like materials to assist the occupant 240 when the occupant 240 is leaning forward. In addition, the computing system can become aware when the occupant 240 would like to readjust the passenger seat 220 into a reclined position. As such, the crew members can then remove the materials associated with the meal so that the occupant 240 can adjust the passenger seat 220 back into a reclined position. The sensors 210 can also provide the sensed video, audio, and motion to the computing system that illustrates when the occupant 240 is performing normal activities without requiring any assistance as well.

Referring to FIG. 2C, the system 200 is depicted with the occupant 240 lying down in the passenger seat 220 next to the window 230 with the sensors 210 sensing the video, audio, and motion of the occupant 240 during a testing period. In such time intervals, the occupant 240 may often be sleeping or relaxing when in such a position as opposed to the upright or forward leaning positions in FIGS. 2A and 2B. During the testing period, the occupant 240 can be sleeping in any number of time intervals. When the occupant 240 is lying down in the passenger seat 220, the passenger 220 can nonetheless still request for assistance and press the call button on multiple occasions during the testing period. The sensors 210 positioned around the occupant 240 can transmit the sensed video, audio, and motion to the computing system during the testing period. The computing system can be aware when the occupant is requesting assistance when the occupant 240 is lying down in the passenger seat 220. As such, the computing system can be aware as to when the occupant 240 would want cabin settings to be adjusted such as the temperature and the lights to enable the occupant to sleep more comfortably. In addition, the computing system can be made aware when the occupant 240 would require an additional blanket, pillow, or bottle of water during the sleeping intervals as well. As such, the sensors 210 can sense the video, audio, and motion in relation to the comfort levels of the occupant 240 based on the body positions and facial patterns sensed during multiple time intervals. The computing system can relay the information to crew members, who can then provide the requested assistance to the occupant 240 during the sleeping intervals, such as adjusting the cabin temperature or dimming the cabin lights, etc.

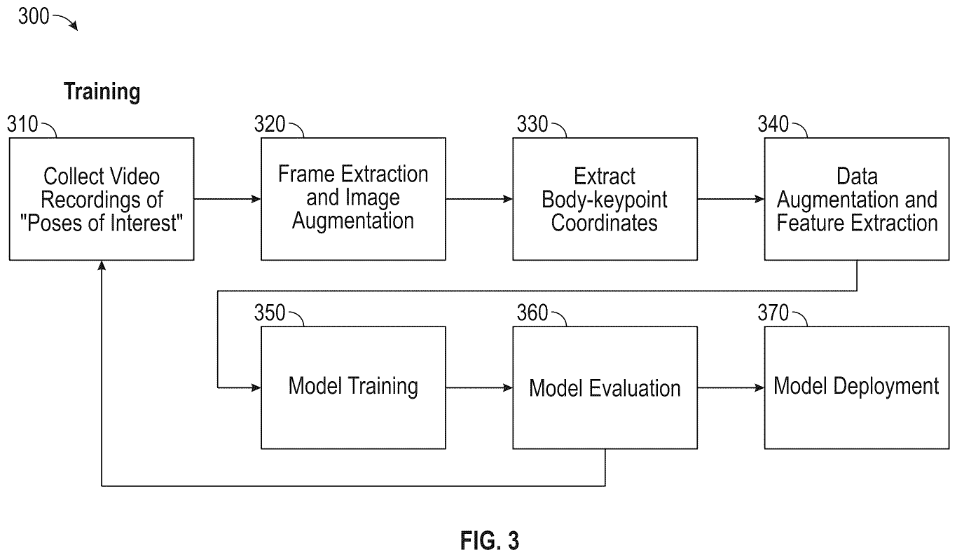

In FIG. 3, a non-limiting embodiment of a training process 300 is illustrated for an AI model of a computing system to identify when occupants in a cabin area require assistance during a testing period on an aircraft or plane. During the testing period, sensors equipped with a USB camera can be inconspicuously placed around each occupant to sense motion and audio of the occupant to provide to the computing system. The computing system can receive the sensed video, audio, and motion from the sensors, and provide alerts to crew members to provide necessary assistance to the occupants and various intervals during the testing period. At 310, video recordings of poses of interest for the occupants can be collected. The AI model can obtain video recordings of the poses of interest from the sensed video from the sensors. The video poses can include head movements, finger movements, movements of the extremities, and body positions of the occupants. The video poses can include the hand, face, knee, and body movements of the occupants that indicate when the occupants would require assistance in the cabin area. Then, at 320, frame extraction and image augmentation can occur. The AI model can perform a frame extraction, image augmentation, and classification of the video poses. Moreover, the AI model can perform frame extraction and image augmentation of the least one occupant requesting assistance can occur during the testing period. The frames and images in which include the finger, head, and body positions in which the occupants are requesting assistance can be captured. Moreover, the frames and images when the occupants are not requesting assistance and performing normal activities can be captured as well.

Referring again to FIG. 3, at 330, the body key point coordinates can be extracted. The body key point coordinates when the occupants are performing normal activities can be extracted. Further, the body key point coordinates when the occupants are requesting assistance for food or a medical emergency or other needs can also be extracted. As such, the computing system can be aware of the body key point coordinates when the occupants are performing normal activities, and also the body key point coordinates when urgent assistance is required. Next, at 340, data augmentation and feature extraction can occur. The data augmentation and feature extraction can involve the computing system augmenting and extracting the data in which occupants requested assistance, and when the occupants did not request assistance.

In FIG. 3, after the data augmentation and feature extraction, model training of the computing system can occur at 350. The AI model of the computing system can be trained to collect the video poses, frame extraction and image augmentation, body key point coordinate extraction, and data augmentation and feature extraction of the least one occupant. As such, the AI model can be trained to perform the tasks described in steps 310-340. At 360, model evaluation of the computing system can occur. The computing system can be evaluated to ensure that the AI model accurately performs the steps described above. The model can be retrained in multiple intervals to ensure that the AI model is accurately performing the steps such as those described in 310 to 340. Next, at 370, model deployment can occur. The AI model within the computing system can be deployed to perform each of the steps described in steps 310 to 340.

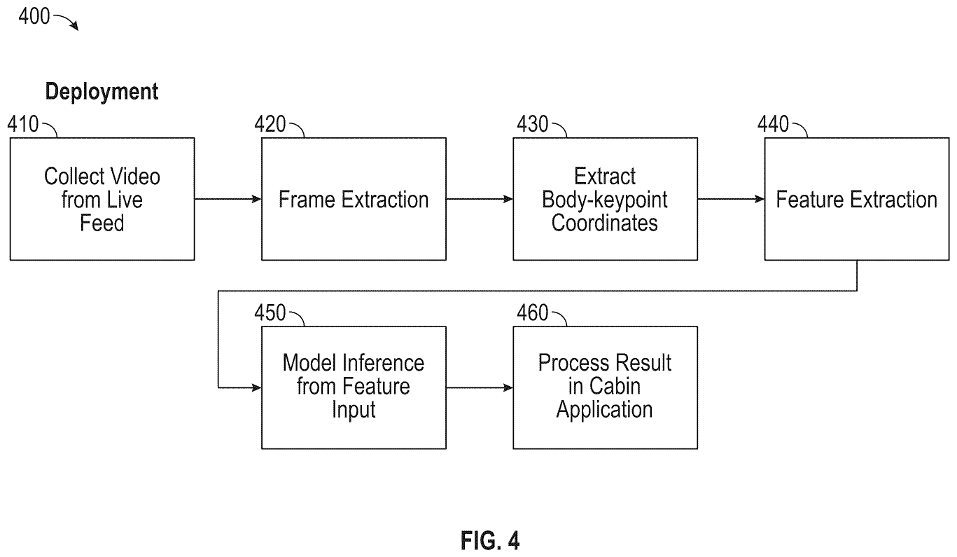

FIG. 4 illustrates a non-limiting embodiment of a deployment process 400 for the AI model of a computing system that is coupled to the sensors positioned around the occupants in the cabin area during a testing period. At 410, video can be collected from the live feed during a testing period. The video that the sensors have sensed of the occupant can be collected by the computing system. At 420, frame extraction can occur. The frame extraction can include extracting images of the normal body, extremity, and finger positions of the occupant when assistance is not required. In addition, the frame extraction can include the body, head, extremity, and finger positions in relevant time intervals when the occupant requested assistance for various needs such as food or medical assistance. Then, at 430, body key point coordinates can be extracted. The body key point coordinates of the occupant can be extracted at various intervals during the testing period. The body key point coordinates can include the various body, extremity, and finger positions of the occupant at various intervals when the occupant requested assistance. Moreover, the body key point coordinates can also be when the least one occupant has performed normal activities without requesting assistance.

In FIG. 4, at 440, feature extraction can occur. With the feature extraction, the body, extremity, finger positions, and other head movements and positions of the occupant and other occupants within the cabin area can be extracted. The AI of the computing system can extract the body movements that include head and finger movements of the least one occupant to identify the various positions in which the least one occupant can require assistance. Then at 450, the model inference from the feature input can occur. With the AI model inference, the AI model incorporated into the computing system, can infer from the feature extraction of 440. Moreover, the AI model can infer the likely body positions that include the finger movements and head positions of when the occupant is requesting assistance, and when the occupant is performing normal activities without requiring assistance. At 460, a process result in cabin application can occur. The AI model can update any schedule within the cabin to anticipate when the occupant will require assistance. As such, crew members can be aware when the occupant will require food, want cabin settings adjusted, or require medical assistance.

Referring to FIG. 4, the deployment process 400 can collect the video feed of the occupant during the testing period. The feed can be collected continuously. The features extraction and frame extraction of the captured video feed can occur to determine how the AI model can infer when the at least occupant will require assistance. The crew members can then be alerted as to when the at least occupant will require assistance. The cabin procedures can thereby be updated to be ready to assist the occupant when the occupant requires assistance.

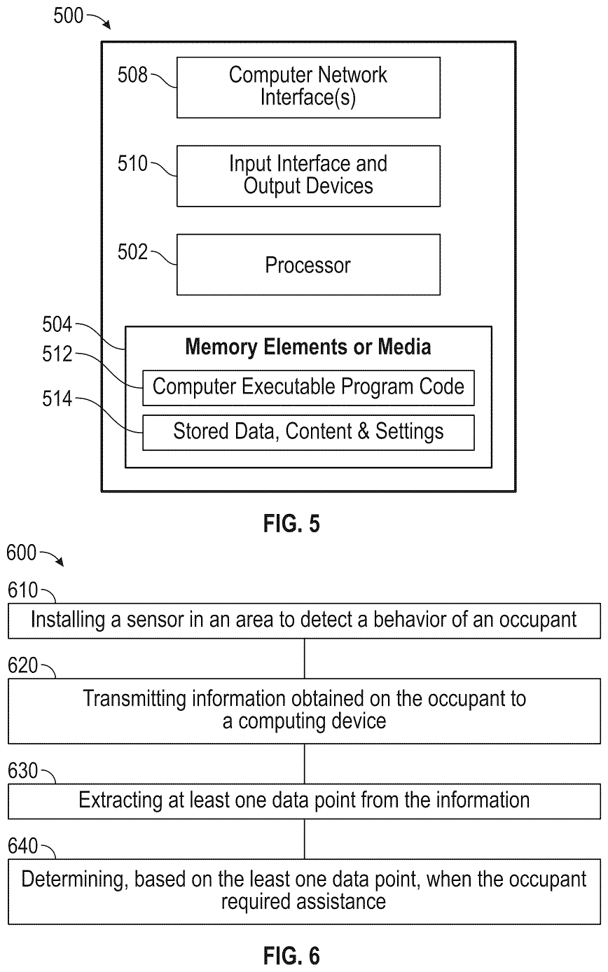

FIG. 5 is a simplified block diagram representation of an exemplary embodiment of a computer-based device 500, which may be used to implement certain devices or systems onboard the aircraft in which the cabin area can be located. The computer-based device 500 can be coupled to the sensors described above in FIGS. 1-4. The device 500 generally includes, without limitation: a processor 502; a memory storage device, storage media, or memory element 504; a communication/computer (network) interface 508; and input interface and output (I/O) devices 510, such as an input interface, one or more output devices, one or more human/machine interface elements, or the like. In practice, the device 500 can include additional components, elements, and functionality that may be conventional in nature or unrelated to the particular application and methodologies described here.

A processor 502 may be, for example, a central processing unit (CPU), a field programmable gate array (FPGA), a microcontroller, an application specific integrated circuit (ASIC), or any other logic device or combination thereof. One or more memory elements/media 504 are communicatively coupled to the processor 502, and can be implemented with any combination of volatile and non-volatile memory. The memory element/media 504 has non-transitory processor-readable and processor-executable computer executable program code (instructions) 512 stored thereon, wherein the instructions 512 are configurable to be executed by the processor 502 as needed. When executed by the processor 502, the instructions 512 cause the processor 502 to perform the associated tasks, processes, and operations defined by the instructions 512. Of course, the memory element/media 504 may also include instructions associated with a file system of the host device 500 and instructions associated with other applications or programs. Moreover, the memory element/media 504 can serve as a data storage unit for the host device 500. For example, the memory element/media 504 can provide storage/stored data, content, and settings 514 for aircraft data, navigation data, sensor data, measurements, image and/or video content, settings or configuration data for the aircraft, and the like.

The computer network interface 508 represents the hardware, software, and processing logic that enables the device 500 to support data communication with other devices. In practice, the computer network interface 508 can be suitably configured to support wireless and/or wired data communication protocols as appropriate to the particular embodiment. For example, the computer network interface 508 can be designed to support a cellular communication protocol, a short-range wireless protocol (such as the BLUETOOTH communication protocol), and/or a WLAN protocol. As another example, if the device 500 is a computer, then the communication interface can be designed to support the BLUETOOTH communication protocol, a WLAN protocol, and a LAN communication protocol (e.g., Ethernet). In accordance with certain aircraft applications, the computer network interface 508 is designed and configured to support one or more onboard network protocols used for the communication of information between devices, components, and subsystems of the aircraft.

The I/O devices 510 enable a user of the device 500 to interact with the device 500 as needed. In practice, the I/O devices 510 may include, without limitation: an input interface to receive data for handling by the device 500; a speaker, an audio transducer, or other audio feedback component; a haptic feedback device; a microphone; a mouse or other pointing device; a touchscreen or touchpad device; a keyboard; a joystick; a biometric sensor or reader (such as a fingerprint reader, a retina or iris scanner, a palm print or palm vein reader, etc.); a camera; a lidar sensor; or any conventional peripheral device.

In FIG. 6, a non-limiting embodiment of a process 600 is illustrated in which sensors equipped with a USB camera can be inconspicuously placed in a cabin area during a testing period. The process 600 can be implemented to identify when occupants in the cabin area would require assistance during multiple time intervals during a testing period. The sensors can sense the video, audio, and motion of the occupants in the cabin area to identify when the occupants may require assistance.

At 610, a sensor can be installed in the cabin area to detect a behavior of an occupant in the area. The sensor can sense the video, audio, and motion of the occupant. The video, audio, and motion can include intervals in which the occupant may request for assistance. The body positions, head positions, extremity positions, and finger positions may also be recorded at the intervals in which the occupant requested assistance. The sensor can be part of a neural network that extracts the information of the occupant in multiple time intervals.

Further, at 620, the information that the sensor has sensed can be transmitted to a computing device communicatively coupled with the sensor. The computing device can be positioned away from the sensor in another portion of the cabin area. Nevertheless, the computing device can be coupled to the sensor, and receive the sensed data of the occupant and other occupants from the sensor. The sensed data can include video, audio, motion and cabin settings such as temperature changes. The information transmitted to the computing device can include video sequences of the occupant in multiple time intervals. Among the video sequences can be the finger movements of the occupant, and a frequency of button presses of the occupant requesting the assistance over multiple time intervals.

At 630, a data point can be extracted from the information obtained by the sensor. Moreover, a machine-learning algorithm can be applied to extract the data point that includes body positions, facial patterns, extremity positions, and finger movements of the occupant. The body positions and facial patterns in which the occupant requested assistance in multiple time intervals can be extracted. The extremity and finger movements in multiple time intervals can be extracted as well. The extremity and finger movements can be in relation to architectural elements or touchpoints in the area that can be included within the data point. The occupant can thereby press the touchpoints in multiple intervals to request for assistance.

Then, at 640, the computing system can determine, based on the data point, an instance in which the occupant required assistance within the cabin area. The computing system can thereby determine when the occupant requested assistance for food or even a

### Medical Emergency.

The embodiments described above in FIGS. 1-6 can provide several technical benefits to the computing system. The computing system can become more efficient at identifying when the occupants may require assistance. As a result, the computing system can more efficiently assist the crew members with the work schedule. The crew members can become more efficient at performing their normal work activities, and also be more efficient in assisting the occupants. The computing system can use the computing resources more efficiently to provide assistance for the occupants as well.

While an exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the disclosure as set forth in the appended claims.

What is claimed is:

1. A method for inconspicuously assessing behavior, the method comprising:
installing a sensor in an area to detect a behavior of an occupant in the area;
transmitting information obtained by the sensor to a computing device coupled with the sensor;
extracting, by the computing device, a data point from the information, wherein a machine-learning algorithm is applied to extract the data point that includes body positions, facial patterns, extremity positions, and finger movements of the occupant, wherein the finger movements in relation to touchpoints in the area are included within the data point; and
determining, based on the data point, an instance in which the occupant required assistance within the area.

2. The method of claim 1, wherein the information obtained by the sensor includes video sequences of the occupant in multiple time intervals.

3. The method of claim 1, further comprising:
applying a neural network within the computing device to extract the information of the occupant in the area at multiple time intervals.

4. The method of claim 1, further comprising:
identifying, by the computing device, from the finger movements of the occupant, a frequency of button presses requesting the assistance over multiple time intervals.

5. The method of claim 1, further comprising:
identifying, by the computing device, from the information obtained by the sensor, relevant interactions between the occupant and other occupants during a testing period within the area.

6. The method of claim 1, further comprising:
identifying, by the computing device, comfort levels of the occupant based on the body positions and facial patterns identified during multiple time intervals.

7. The method of claim 1, further comprising:
identifying, by the computing device, time intervals when the occupant requires privacy.

8. The method of claim 1, further comprising:
determining, by the computing device, time intervals based on the data point when the occupant enters sleeping intervals.

9. The method of claim 1, further comprising:
identifying, by the computing device, specific time intervals when the occupant requests for adjustments in a temperature in the area based on the information obtained by the sensor.

10. A non-transitory machine-readable storage medium that provides instructions that, when executed by a processor, are configurable to cause the processor to perform operations comprising:
installing a sensor in an area to detect a behavior of an occupant in the area;
transmitting information obtained by the sensor to a computing device coupled with the sensor;
extracting a data point from the information, wherein a machine-learning algorithm is applied to extract the data point that includes body positions, facial patterns, extremity positions, and finger movements of the occupant, wherein the finger movements in relation to touchpoints in the area are included within the data point; and
determining, based on the data point, an instance in which the occupant required assistance within the area.

11. The non-transitory machine-readable storage medium of claim 10, wherein the data point indicates a frequency in which the occupant pressed touchpoint buttons in the area to request the assistance.

12. The non-transitory machine-readable storage medium of claim 10, wherein the instructions are configurable to cause the processor to:
determine the body positions in which the occupant requested the assistance in multiple time intervals.

13. The non-transitory machine-readable storage medium of claim 10, wherein the instructions are configurable to cause the processor to:
identify the facial patterns in multiple time intervals of the occupant that identify when the occupant required the assistance in the area.

14. The non-transitory machine-readable storage medium of claim 10, wherein the instructions are configurable to cause the processor to:
determine intervals in a testing period in which the occupant did not require the assistance.

15. The non-transitory machine-readable storage medium of claim 10, wherein the instructions are configurable to cause the processor to:
identify conditions in the area that have to be adjusted based on the body positions of the occupant.

16. A computing system comprising:
a non-transitory machine-readable storage medium that stores software; and
a processor, coupled to the non-transitory machine-readable storage medium, to execute the software to perform operations comprising:
installing a sensor in an area to detect a behavior of an occupant in the area;
transmitting information obtained by the sensor to a computing device coupled with the sensor;
extracting a data point from the information, wherein a machine-learning algorithm is applied to extract the data point that includes body positions, facial patterns, extremity positions, and finger movements of the occupant, wherein the finger movements in relation to touchpoints in the area are included within the data point; and
determining, based on the data point, an instance in which the occupant required assistance within the area.

17. The computing system of claim 16, wherein the data point includes relevant time intervals in which the occupant required the assistance in the cabin area.

18. The computing system of claim 16, wherein the finger movements involved requests by the occupant in relation to a medical situation.

19. The computing system of claim 16, wherein the information obtained by the sensor includes captured video sequencies continuously captured in multiple time intervals.

20. The computing system of claim 16, wherein the data point includes the body positions in which the occupant did not require the assistance within the area.
